(19) United States
(12) Patent Application Publication
(10) Pub. No.: US 2010/0318824 A1
(43) Pub. Date: Dec. 16, 2010

(54) STORAGE DEVICE WITH ADVANCED POWER MANAGEMENT

(75) Inventor: Joshua Bartholomew Tinker, Fort Collins, CO (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/481,844

(22) Filed: Jun. 10, 2009

(51) Int. Cl. G06F 1/32

(52) U.S. Cl. 713/323

(57) ABSTRACT

In a particular embodiment, a data storage device includes a controller. The controller includes device performance management logic to retrieve an advanced power management (APM) setting from an APM register of a host system. The APM register includes a plurality of register settings adapted to represent a respective plurality of APM settings. The controller further includes policy selection logic to select at least one storage device (SD) policy from a plurality of SD policies based on the determined APM setting and configuration logic to apply the selected at least one SD policy to adjust at least one of a performance characteristic and a power characteristic associated with first and second data storage media.

### FIELD

The present invention relates generally to data storage devices with advanced power management, and more particularly but not by limitation to a data storage device that includes multiple power consumption and performance levels.

### BRIEF DESCRIPTION OF THE DRAWINGS

FIG. 1 is a block diagram of a particular illustrative embodiment of a system including a hybrid data storage device having a controller to selectively apply a particular configuration based on an advanced power management (APM) register setting;

FIG. 2 is a block diagram of a second particular illustrative embodiment of a system including a data storage device having a controller to selectively apply a particular configuration based on an advanced power management (APM) register setting;

FIG. 3 is a block diagram of a particular embodiment of a system including an APM register having multiple APM register settings and including storage device firmware having multiple corresponding storage device configurations;

FIG. 4 is a block diagram of a second particular embodiment of a system including an APM register having multiple APM register settings and including storage device firmware having multiple corresponding storage device configurations; and

FIG. 5 is a flow diagram of a particular illustrative embodiment of a method of selectively applying a storage device configuration.

### DETAILED DESCRIPTION OF ILLUSTRATIVE EMBODIMENTS

Portable electronic devices, such as mobile telephones, portable computers, personal digital assistants (PDAs), and other portable electronic devices, can utilize battery power for portions of their operating time. Such devices may selectively reduce power to various components to extend the battery life, allowing the devices to be used for an extended period of time. Data storage devices, such as hard disc drives, can be used to store data for use by such portable electronic devices. However, command sets associated with the portable electronic devices may not communicate power states to a data storage device.

In a particular embodiment, a controller of a data storage device including data storage media can selectively adjust power and performance parameters for selected data storage media and associated circuitry. For example, in a data storage device that includes a solid-state data storage medium and a disc data storage medium, the controller can adjust power parameters (such as selectively reducing or increasing power to selected circuit components) and performance characteristics (such as selectively altering seek/settle time parameters associated with a read/write head of a disc data storage medium, data caching parameters, memory partitioning parameters, other performance parameters, or any combination thereof). In a particular example, the controller is adapted to apply a selected storage device configuration to alter performance and power characteristics of circuitry associated with both the solid-state data storage medium and the disc data storage medium.

In a particular illustrative embodiment, a controller of a storage device is adapted to retrieve data related to an advanced power management (APM) setting from an APM register of a host system and to dynamically balance performance and power consumption based on the retrieved data. In a particular example, the controller is adapted to selectively apply a power and performance configuration that corresponds to a level along a scale that ranges from higher power consumption and higher performance to lower power consumption and lower performance. In a particular embodiment, high performance exacts a price in terms of power consumption, and reducing power consumption can lead to reduction in performance (i.e., response time).

In a particular example, the APM register can include 255 register settings to manage operation of the host system (balancing power consumption and performance), and the scale can include 255 corresponding levels of power consumption and performance. In a particular embodiment, the data storage device can include a corresponding number of power and performance settings (configurations) to allow the controller of the data storage device to control power settings of the data storage device in conjunction with the APM settings of the host system, thereby enhancing overall system performance and bringing more value to the overall system. In a particular example, the data storage device can facilitate the whole system to sometimes have higher performance and other times having lower power consumption. In a particular embodiment, the storage device uses APM settings retrieved from the host system to adjust its performance and power consumption parameters to deliver improved system performance and reduced overall energy consumption.

In a particular embodiment, a data storage device can include any number of power savings modes (or levels), which may correspond to APM register settings with a desired level of granularity. Each power savings mode can include instructions for adjusting power to selected circuits, adjusting memory partitioning parameters, adjusting performance parameters, adjusting timing thresholds, adjusting performance thresholds, or any combination thereof. In a particular example, a difference between one configuration and another may include the same power settings but different power management timers or timing thresholds, allowing the data storage device to advance to deeper power states faster (even spinning down a hard disc drive). In an example, the timing threshold may define an interval after which the controller advances to a next mode. Spinning down the disc drive can lead to a performance tradeoff between reducing power consumption and increasing a time it takes for the data storage device to return from a reduced-power state to an active state.

In a particular embodiment, the data storage device includes a plurality of configurations and a controller that is responsive to APM settings of the APM register to selectively apply at least one of the plurality of configurations. The plurality of configurations corresponding to the APM register settings can dramatically widen the ability of the data storage device to deliver significant performance gains at the high power and performance settings and to deliver lower (and adequate) performance while consuming less power. By using the APM settings information to adjust performance, the storage device can deliver adequate performance with average or below average power consumption than is possible for standard hard drives at lower power and performance settings. In a particular example, the number of possible storage device (SD) configurations can be related to the number of possible APM register settings. In a particular embodiment, the number of possible SD configurations can match the number of possible APM register settings. In another example, the number of possible configurations can be a fraction of the number of possible APM register settings, such as 25 or 50 configurations for 255 APM register settings.

In a particular embodiment, the data storage device is adapted to tune a caching algorithm differently based on the APM register setting. Further, in another particular embodiment, the data storage device can prioritize caching differently in a high power/performance state than in a low power/performance state. In a particular example, the data storage device can implement a power/performance algorithm that focuses on cache hits that are “expensive” from a disc performance perspective. For example, long seeks (large spatial locality) and small data size transfers can be cached to improve performance in a first power/performance mode. In a second power/performance mode, power can be reduced to a rotatable storage medium and all data transfers can be performed via a solid-state storage medium, such as a cache memory. In this latter case, caching can be used to prioritize all data transfers while keeping a small space reserved for write caching operations. In a particular illustrative example, a large portion of hard disc spin-ups are caused by read cache misses. To reduce power consumption due to such spin-ups, a controller of the data storage device can implement a power/performance algorithm that would cache all writes and put all expected logical block addresses (LBAs) in the solid-state storage medium, which can be a non-volatile cache.

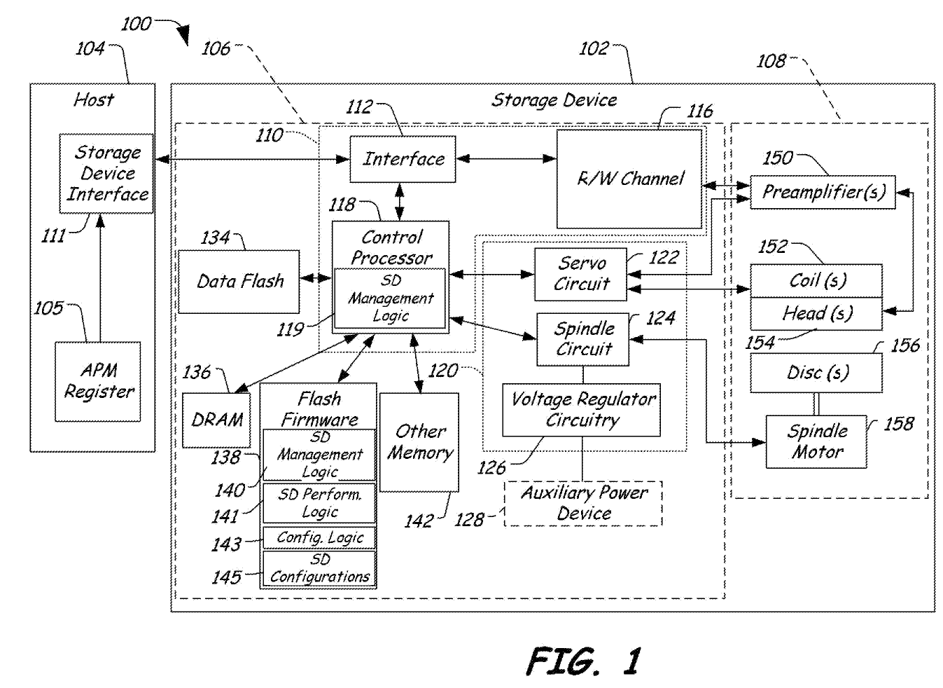

FIG. 1 is a block diagram of a particular illustrative embodiment of a system 100 including a hybrid data storage device 102 having a controller to selectively apply a particular storage device (SD) configuration based on an advanced power management (APM) register setting. As used herein, the term “hybrid storage device” refers to a storage device that includes a first data storage medium and a second data storage medium. In a particular embodiment, hybrid storage device may refer to a storage device that includes both a solid-state data storage medium and disc data storage medium. Further, as used herein, the term “solid-state storage medium” refers to storage medium that utilizes semiconductor properties to represent data values and that has no moving parts to record or retrieve the data.

The hybrid storage device 102 includes both a disc data storage medium (one or more discs 156) and a solid-state data storage medium, such as a flash memory device (data flash 134, flash firmware 138, other solid-state memory, or any combination thereof). The hybrid storage device 102 is adapted to communicate with a host system 104. In a particular embodiment, the host system 104 can be a computer, a processor, a mobile telephone, a personal digital assistant (PDA), another electronic device, or any combination thereof. In a particular example, the hybrid storage device 102 can communicate with the host system 104 via a universal serial bus (USB), a serial advanced technology attachment (SATA) interface, another type of communication interface, or any combination thereof. In another particular example, the hybrid storage device 102 can communicate with the host system 104 via a fiber channel interface, another type of high speed interface, or any combination thereof. In another particular example, the hybrid storage device 102 can be a stand-alone device that is adapted to communicate with the host system 104 via a network, such as via a network cable using a networking protocol.

The hybrid storage device 102 includes recording subsystem circuitry 106 and a head-disc assembly 108. The recording subsystem circuitry 106 includes storage device read/write control circuitry 110 and disc-head assembly control circuitry 120. The recording subsystem circuitry 106 further includes an interface circuit 112, which includes a data buffer for temporarily buffering data received via the interface circuit 112 and which includes a sequencer for directing the operation of the read/write channel 116 and the preamplifier 150 during data transfer operations. The interface circuit 112 is coupled to the host system 104 and to a control processor 118, which is adapted to control operation of the hybrid storage device 102.

In a particular embodiment, the control processor 118 can be adapted to execute storage device (SD) management logic 119 to access an advanced power management (APM) register 105 of the host system 104, via the interface 112 and the storage device (SD) interface 111 to retrieve an APM setting. In a particular example, the control processor 118 can provide an instruction to the host system 104 via the interface 112 and the SD interface 111 that is executable by a processor (not shown) of the host system 104 to retrieve a setting of the APM register 105 and to provide data related to the APM register setting to the control processor 118. The control processor 118 is adapted to utilize storage device performance management logic 141 to select a storage device configuration from a plurality of storage device configurations 145 and is adapted to use configuration logic 143 to configure one or more parameters of the storage device 102 by applying the selected storage device configuration. The plurality of storage device configurations 145 includes multiple configurations and/or policy settings having different power consumption characteristics and different performance characteristics to control power and performance of the first and second data storage media, such as the one or more discs 156 and the data flash memory 134, for example.

The control processor 118 is coupled to a servo circuit 122 that is adapted to control the position of one or more read/write heads 154 relative to the one or more discs 156 as part of a servo loop established by the one or more read/write heads 154. The one or more read/write heads 154 can be mounted to a rotary actuator assembly to which a coil 152 of a voice coil motor (VCM) is attached. The VCM includes a pair of magnetic flux paths between which the coil 152 is disposed so that the passage of current through the coil 152 causes magnetic interaction between the coil 152 and the magnetic flux paths, resulting in the controlled rotation of the actuator assembly and the movement of the one or more heads 154 relative to the surfaces of the one or more discs 156. In a particular embodiment, the one or more discs 156 represent rotatable, non-volatile storage media. The servo circuit 122 is used to control the application of current to the coil 152, and hence the position of the heads 154 with respect to the tracks of the one or more discs 156.

The disc-head assembly control circuitry 120 includes the servo circuit 122 and includes a spindle circuit 124 that is coupled to a spindle motor 158 to control the rotation of the one or more discs 156. The hybrid storage device 102 also includes an auxiliary power device 128 that is coupled to voltage regulator circuitry 126 of the disc-head assembly control circuitry 120 and that is adapted to operate as a power source when power to the hybrid storage device 102 is lost. In a particular embodiment, the auxiliary power device 128 can be a capacitor or a battery that is adapted to supply power to the hybrid storage device 102 under certain operating conditions. In a particular example, the auxiliary power device 128 can provide a power supply to the recording subsystem assembly 106 and to the disc-head assembly 108 to record data to the one or more discs 156 when power is turned off. Further, the auxiliary power device 128 may supply power to the recording subsystem assembly 106 to record data to the data flash 134 when power is turned off.

Additionally, the hybrid storage device 102 includes the data flash memory 134, a dynamic random access memory (DRAM) 136, firmware 138 (i.e., a solid-state memory, such as a flash memory), other memory 142, or any combination thereof. In a particular embodiment, the firmware 138 is accessible to the control processor 118 and is adapted to store the storage device management logic 140, the storage device performance management logic 141, the configuration logic 143, and the storage device configurations 145.

In a particular embodiment, the control processor 118 is adapted to receive data related to an APM register setting associated with the APM register 105 of the host system 104. In a particular embodiment, the host system 104 can provide data related to the APM register setting to the storage device 102 in response to a command or execution of an instruction provided to the host system 104 by the storage device 102. In a particular example, the data may be sent by the host system 104 in response to a command provided by the storage device 102. Based on the APM register setting, the control processor 118 is adapted to selectively apply a storage device configuration from the multiple storage device configurations 145 to alter at least one of a power characteristic and a performance characteristic of the storage device 102. In particular, the control processor 118 can adjust a performance characteristic of at least one of the one or more discs 156 and the solid-state data storage medium (such as the data flash memory 134).

In a particular example, the APM register 105 is adapted to store a power management setting, which setting can be used to configure a corresponding power consumption parameter of the storage device 102. In a particular illustrative example, the APM register 105 can store any number of register bits representing a corresponding number of settings. For example, the APM register 105 can have 255 bit settings to represent up to 255 different power management settings (APM settings), where each APM setting represents a different level on a scale of power consumption and performance. In a particular example, the scale ranges from high power consumption and high performance to low power consumption and lower (slower or reduced) performance. In a particular embodiment, the storage device configurations 145 can represent any number of levels.

In a particular embodiment, the number of storage device configurations 145 can represent a number of possible APM register settings of the APM register 105. For example, if the APM register 105 stores 255 APM register settings, the storage device configurations 145 can include 255 different configurations. Alternatively, the APM register 105 can represent 255 different power settings, and the storage device configurations 145 can include a fraction of the different settings. For example, the storage device configurations 145 can include 10, 25, 50, or another number of configurations and multiple timing options for determining how long the control processor 118 should wait before moving to a deeper (lower) power level (or state). In a particular example, a first ten APM register values (i.e., from zero to nine) can represent a first storage device configuration and a timing option (such a four minutes) or multiple timing options (such as (four minutes, two minutes, etc.) for each of the levels. Additionally, a next ten APM register values (i.e., from ten to nineteen) can represent a second storage device configuration and at least one second timing option.

In a particular example, it should be understood that the control processor 118 is adapted to selectively apply a storage device configuration that corresponds to a power management setting retrieved from the APM register 105. In a particular example, the host system 104 can use the APM register 105 to configure its own power/performance settings. The control processor 118 of the storage device 102 can use the same APM register setting to configure power and performance parameters of the storage device 102 (and of the data storage media, including the one or more discs 156 and the data flash memory 134) to conform to the power and performance settings of the host system 104. In a particular example, the granularity of the APM register 105 can allow the storage device 102 to utilize a variety of configurations to provide enhanced performance at reduced power consumption levels and to provide reduced power consumption at high performance levels.

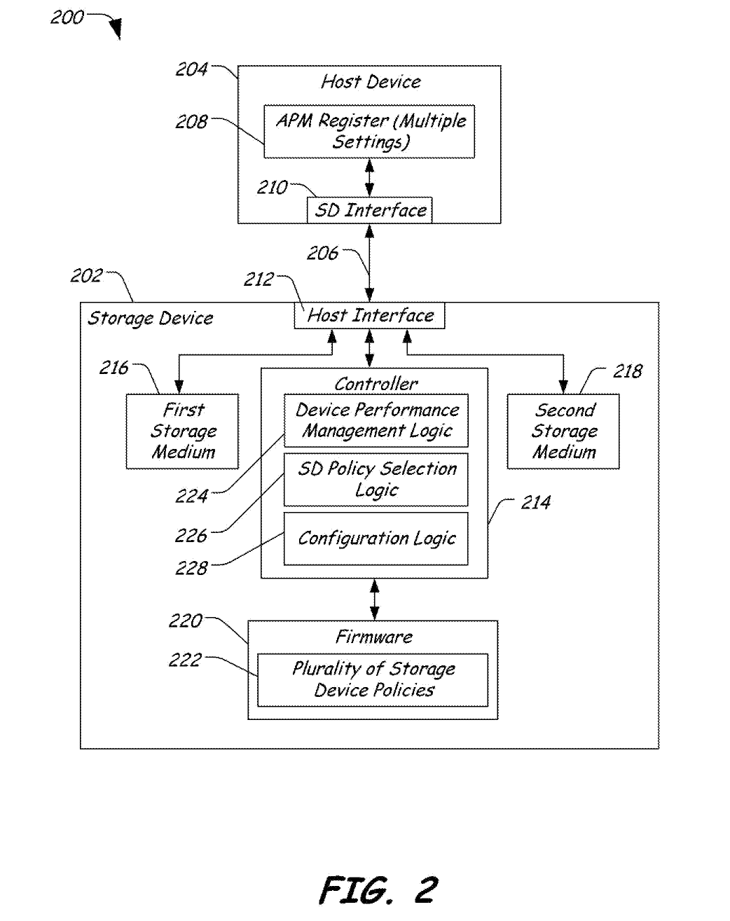

FIG. 2 is a block diagram of a second particular illustrative embodiment of a system 200 including a data storage device 202 having a controller 214 to selectively apply a particular configuration based on an advanced power management (APM) register setting. The data storage device 202 is adapted to communicate with a host device 204 via a host bus 206. In a particular embodiment, the host device 204 can be a computing device, such as a portable computer, a mobile telephone, a personal digital assistant (PDA), another electronic device, or any combination thereof. The host device 204 includes an advanced power management (APM) register 208 having multiple possible APM settings. In a particular embodiment, the APM register 208 includes a plurality of register settings adapted to represent a respective plurality of APM settings, which instruct the data storage device 202 where to operate on a scale that balances power consumption and performance. The host device 204 further includes an interface 210 coupled to the APM register 208 and to the data storage device 202 via the host bus 206.

The data storage device 202 includes a host interface 212 that is coupled to the host system 204 via the host bus 206. The data storage device 202 further includes a controller 214 that is coupled to a first data storage medium 216 and a second data storage medium 218. In a particular embodiment, the first and second storage media 216 and 218 can be solid-state storage media, such as flash memories, magnetic random access memories (MRAM), other non-volatile solid-state storage media, or any combination thereof. In another particular embodiment, the first storage medium 216 can be a solid-state data storage medium, and the second storage medium 218 can be a rotatable (disc) data storage medium. Further, the controller 214 is coupled to firmware 220, which includes a plurality of storage device (SD) policies 222. In a particular embodiment, the plurality of SD policies 222 includes different storage device policies that have different power consumption and performance characteristics. The controller 214 includes device performance management logic 224 to determine an advanced power management (APM) setting related to the APM register 208 associated with the host system 204. The controller 214 further includes policy selection logic 226 to select at least one storage device (SD) policy from a plurality of SD policies 222 based on the determined APM setting. Further, the controller 214 includes configuration logic 228 to apply the selected SD policy to adjust at least one of a performance characteristic and a power characteristic of the first and second data storage media 216 and 218.

In a particular embodiment, each SD policy of the plurality of SD policies 222 represents a level on a scale that ranges from high power consumption and high performance to low power consumption and low performance for the storage device 202. The scale relates to a plurality of APM settings within the APM register 208. In a particular example, the plurality of APM settings of the APM register 208 includes 255 register settings, and the plurality of SD policies 222 includes a respective 255 SD policies.

In a particular embodiment, the controller 214 is adapted to initiate a process to retrieve the APM setting from the APM register 208 at selected intervals, aperiodically, or in response to a trigger, such as an interrupt, an interface command, a boot process, or any combination thereof. In another particular embodiment, the controller 214 can initiate the process to retrieve the APM setting upon startup, at another time, or any combination thereof.

In a particular example, the plurality of storage device policies 222 includes a first policy to reduce power to the first data storage medium 216 and to adjust a memory partitioning parameter to store data to the second data storage medium 218 and includes a second policy to provide power to the first data storage medium 216 and to adjust the memory partitioning parameter to selectively storage data to one of the first and the second data storage media 216 and 218. The plurality of SD policies 222 further includes a third policy having a first caching algorithm associated with the second data storage medium 218 and includes a fourth policy having a second caching algorithm associated with the second data storage medium 218. Additionally, the plurality of SD policies 222 includes a fifth policy having a first caching priority to identify performance intensive read access requests associated with the first data storage medium 216 and to store data associated with the identified requests to the second data storage medium 218 and includes a sixth policy having a second caching priority to store data and expected logical block addresses in the second data storage medium 218.

In another particular embodiment, the plurality of storage device policies 222 includes multiple different storage device configurations that define various aspects of power and performance characteristics of the storage device 202. For example, a memory partitioning characteristic that defines where to store data received via the host interface 212 (i.e., whether to store the received data in the first storage medium 216, the second storage medium 218, or any combination thereof) can impact power consumption and performance. In a particular example, if all received data is stored at the first storage medium 216, power can be reduced to the second storage medium 218 (or vice versa). However, by reducing power to the second storage medium 218, performance of the storage device 202 may be negatively impacted, in part, because the time to return to an active state from the reduced power state may reduce responsiveness of the data storage device 202.

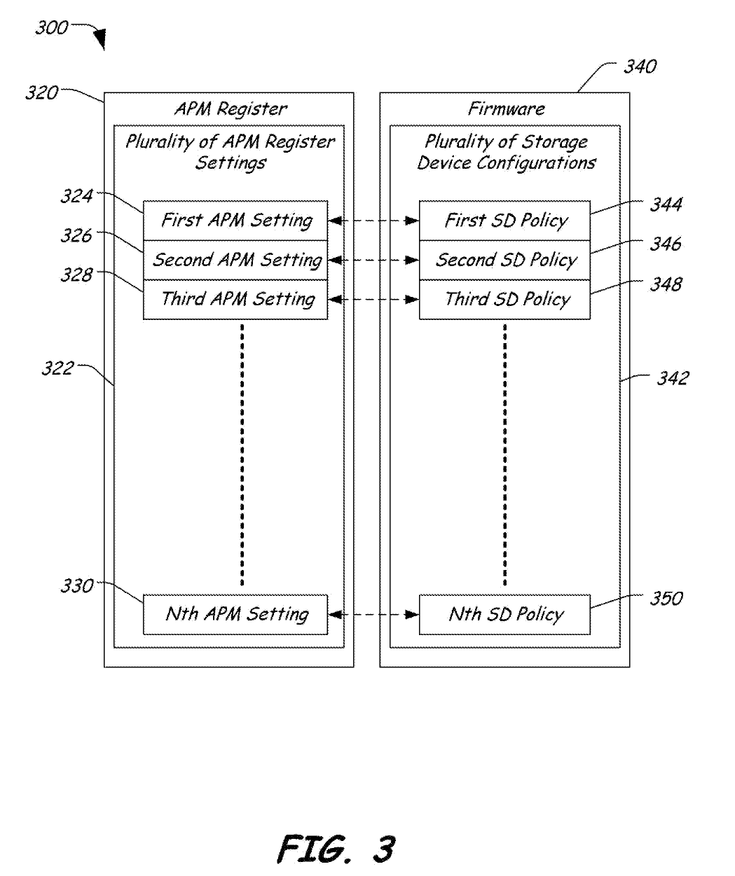

FIG. 3 is a block diagram of a particular embodiment of a system 300 including an advanced power management (APM) register 320 having multiple APM register settings 322 and including storage device firmware 340 having multiple corresponding storage device configurations 342. The multiple APM register settings 322 include a first APM setting 324, a second APM setting 326, a third APM setting 328, and an N-th APM setting 330. The multiple storage device (SD) configurations 342 include a first SD policy 344, a second SD policy 346, a third SD policy 348, and an N-th SD policy 350. In a particular embodiment, the APM register 320 can include any number of possible APM settings. In a particular example, the APM register 320 can include 255 bit settings, which can represent 255 different power management levels. In this particular example, the first, second, third, and N-th APM settings 324, 326, 328, and 330 correspond to a respective storage device configuration or policy, such as the first, second, third, and N-th SD policies 344, 346, 348, and 350.

In a particular embodiment, a host device is adapted to configure the APM register 320 to specify a particular APM setting, such as the third APM setting 328, which corresponds to a respective storage device policy, such as the third SD policy 348. In this particular embodiment, the multiple SD configurations 342 can have a one-to-one correspondence to a number of levels of settings within the APM register 320. Thus, if the APM register 320 has 255 different levels, the multiple SD configurations 342 can include 255 different policies or configurations. Each of the multiple SD configurations 342 can represent a different power consumption characteristic, a different performance characteristic, or any combination thereof.

In a particular example, each SD configuration of the multiple SD configurations 342 may specify a particular power configuration to reduce or turn off power to selected circuitry of associated with a first and a second data storage media. Additionally, the SD configuration can specify adjustments to performance parameters, such as servo loop thresholds, read error rate thresholds, background scan parameters to fix data storage areas, other performance parameters, or any combination thereof. Further, the SD configurations can include a variety of memory partition parameters that specify where data is stored, whether it is stored in a first data storage medium, a second data storage medium, the priority of changing data in one or more data storage media, or any combination thereof.

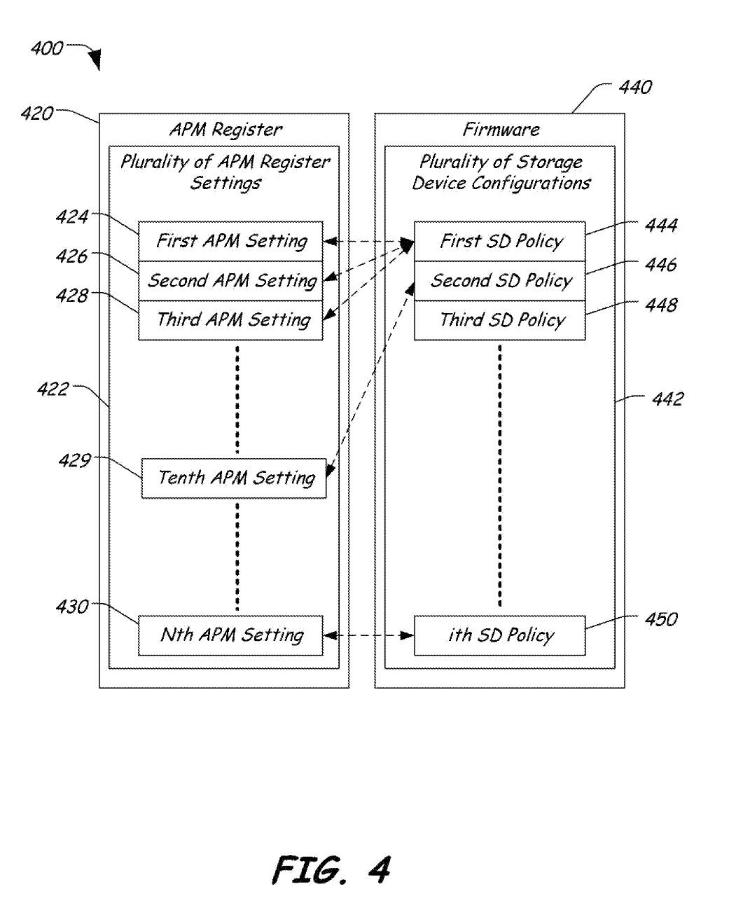

FIG. 4 is a block diagram of a second particular embodiment of a system 400 including an advanced power management (APM) register 420 having multiple APM register settings 422 and including storage device firmware 440 having multiple corresponding storage device configurations 442. The multiple APM register settings 422 include a first APM setting 424, a second APM setting 426, a third APM setting 428, a tenth APM setting 429, and an N-th APM setting 430. In a particular embodiment, the APM register 420 can include any number of possible APM settings. In a particular example, the APM register 420 can include 255 bit settings, which can represent 255 different power management levels. The multiple storage device (SD) configurations 442 include a first SD policy 444, a second SD policy 446, a third SD policy 448, and an i-th SD policy 450. In a particular embodiment, the multiple SD configurations 442 can include a number of configurations or policies that represent a fraction of the number of APM register settings 422.

In a particular embodiment, the first, second, and third APM settings 424, 426, and 428 represent different combinations of power consumption and performance with respect to the first SD policy 444. In a particular example, a difference between the first and second APM settings 424 and 426 may include a time setting to indicate how long the storage device is to wait before proceeding to a deeper power level, which may be represented by the second SD policy 446. In a particular example, the first APM setting 424 may specify a power and performance characteristic having a timing interval of approximately five minutes. The second APM setting 426 may specify the same power and performance characteristic, but with a different timing interval, such as 2.5 minutes. It should be understood that the timing intervals are provided for illustrative purposes only and that other timing intervals may be used. In a particular example, the storage device may be adapted to move from one SD policy to a next SD policy, representing different power consumption levels, after the specified timing interval has elapsed. Further, it should be understood that other parameters may be adjusted, such as memory partitioning parameters, servo loop settings, seek/settle criteria, other parameters, or any combination thereof.

Further, in the example provided above, the tenth APM setting 429 can correspond to the second SD policy 446. Further, an eleventh, twelfth, thirteenth, and other APM settings may also correspond to the second SD policy 446, but may introduce different timing intervals for determining how quickly the controller of the data storage device can advance to a lower power level based on inactivity, for example. Alternatively, the different levels can introduce other performance parameter adjustments, such as servo-loop settings, seek/settle criteria, memory partitioning parameters, caching policies, other parameters, or any combination thereof. In this particular example, the plurality of APM register settings 422 can include 255 different register settings, and the plurality of storage device configurations 442 can include 25 different storage device policies (or configurations) 442. In this instance, the granularity of the APM register settings 422 can specify an initial storage device policy or configuration from the plurality of storage device configurations 442 and can specify a timing interval or an activity threshold level to specify how quickly the controller can advance to a next configuration level or can specify a performance parameter to be adjusted. In a particular example, the controller of the storage device may monitor activity related to a data storage medium or activity related to received data or storage device commands received at a host interface to determine whether the data storage device should advance to a deeper power state and to specify how the next deeper power state is to be achieved, such as by selectively deactivating particular circuitry.

In a particular example, the controller of the data storage device can implement a selected storage device policy, such as the third storage device policy 448 based on a particular setting from the APM register 420. In this instance, the controller can maintain the selected storage device policy until the APM register setting is changed or until a detected activity level and a timing interval associated with the selected storage device policy allow the controller to proceed to a next storage device policy level. In a particular example, the controller may selectively deactivate circuitry (such as reducing power to a rotatable storage medium) and alter internal data storage policies (such as memory partitioning, a read access optimization strategy, a servo loop, other data storage device settings, or any combination thereof) in response to a determined APM setting from the plurality of APM register settings 422. Further, the determined APM register setting can specify a time interval (such as 25 milliseconds, for example), and the controller can step through a series of power reduction, performance reduction, or other configuration changes according to the specified time interval.

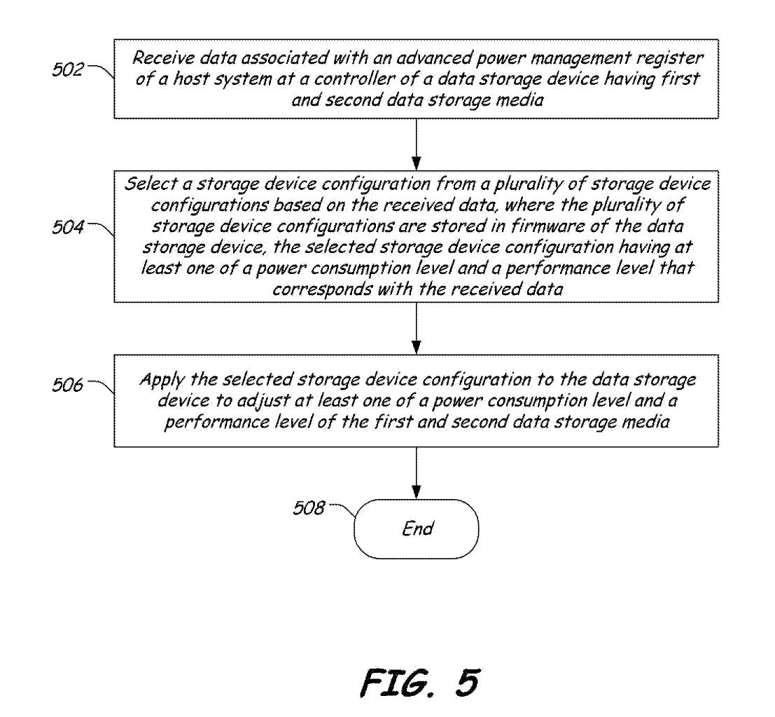

FIG. 5 is a flow diagram of a particular illustrative embodiment of a method of selectively applying a storage device configuration. At 502, data associated with an advanced power management (APM) register of a host system is received at a controller of a data storage device having first and second data storage media. In a particular embodiment, the controller can initiate retrieval of the data from the APM register by sending an instruction to the host system that is executable by a processor of the host system to return the data. In another particular embodiment, the APM register is accessible to the controller. In still another particular embodiment, the host system can send the data to the controller periodically, aperiodically, on startup, whenever the APM register is updated, or any combination thereof.

Continuing to 504, a storage device configuration is selected from a plurality of storage device configurations based on the received data, where the plurality of storage device configurations are stored in firmware of the data storage device and where the selected storage device configuration has at least one of a power consumption level and a performance level that corresponds with the received data. In a particular example, the storage device includes a solid-state storage medium (the second data storage medium) and a rotatable (disc) data storage medium (the first data storage medium). The rotatable storage medium may produce a first acoustic noise when the rotatable storage medium is spun at first rotational velocity and produce a second acoustic noise when the rotatable storage medium is spun at a second rotational velocity. Further, rotation of the rotatable storage medium may consume a first power at the first rotational velocity and a second power at the second rotational velocity. Finally, the rotatable storage medium may have a first performance characteristic at the first rotational velocity and a second performance characteristic at the second rotational velocity.

Proceeding to 506, the selected storage device configuration is applied to the data storage device to adjust at least one of a power consumption leveland a performance level of the first and second data storage media. In a particular embodiment, the selected storage device configuration can include a first policy to reduce power to a first data storage medium and to adjust a memory partitioning parameter to store data to a second data storage medium. In a first example, the first and second data storage media can be solid-state storage devices. In another example, the first data storage medium can be a solid-state data storage medium, and the second data storage medium can be a rotatable (disc) data storage medium. In another embodiment, the selected storage device configuration includes a second policy to provide power to the first data storage medium and to adjust the memory partitioning parameter to selectively storage data to one of the first and the second data storage medium. In still another embodiment, the selected storage device configuration a third policy having a first caching algorithm associated with the second data storage medium. In yet another particular embodiment, the selected storage device configuration includes a fourth policy having a second caching algorithm associated with the second data storage medium.

Additionally, in another embodiment, the selected storage device configuration includes a fifth policy having a first caching priority to identify performance intensive read access requests associated with the first data storage medium and to store data associated with the identified requests to the second data storage medium. In still another embodiment, the selected storage device configuration includes a sixth policy having a second caching priority to store data and expected logical block addresses in the second data storage medium. The method terminates at 508.

While the above-discussion has largely focused on an advanced power management (APM) implementation including an APM register, it should be understood that similar registers may be used to store acoustic management settings for the host device, which settings may be used by an associated storage device to control and to adjust parameters that affect acoustic emissions and device performance.

It should be understood that the particular power savings or acoustic reduction policies that are applied by the controller can vary based on the components of the data storage device. Further, the data storage device can include any number of storage device configurations, each of which may have different power consumption characteristics, different acoustic characteristics, different performance characteristics, or any combination thereof.

In conjunction with the systems and methods disclosed above with respect to FIGS. 1-5, a data storage device is disclosed that includes a controller adapted to determine a power management setting associated with a host system based on an advanced power management (APM) register of the host system. The data storage device is adapted to selectively apply a storage device configuration or policy to the data storage device based on the power management setting to adjust a power consumption characteristic, an acoustic noise generation characteristic, a performance characteristic, or any combination thereof. In a particular example, the data storage device can reduce its power consumption to correspond to a power management setting of the host device. In a particular illustrative example, the host system is adapted to utilize a T-13 non-volatile (NV) Cache Command Set, and the APM register can be used by the host system to configure its power consumption and performance. In this instance, the data storage device is adapted to take advantage of the existing APM register settings to configure itself to correspond to a desired power and performance setting of the device.

It is to be understood that even though numerous characteristics and advantages of various embodiments have been set forth in the foregoing description, together with details of the structure and function of various embodiments, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the data storage system system while maintaining substantially the same functionality without departing from the scope and spirit of the present invention. In addition, although an embodiment described herein is directed to a data storage system having a controller that is responsive to an advanced power management (APM) register of a host system for providing multiple reduced power states or levels that correspond to different settings of the APM register, it will be appreciated by those skilled in the art that the teachings of the present invention can be applied to an acoustic management register, a performance management register, or other host-controlled signals or commands that can be used to reduce power consumption by the data storage device, without departing from the scope and spirit of the present disclosure.

What is claimed is:

1. A data storage device comprising:
a controller comprising:
a first circuit to retrieve an advanced power management (APM) setting from an APM register of a host system, the APM register including a plurality of register settings adapted to represent a respective plurality of APM settings;
a second circuit to select at least one storage device policy from a plurality of storage device policies based on the determined APM setting; and
a third circuit to apply the selected at least one storage device policy to adjust at least one of a performance characteristic and a power characteristic associated with first and second data storage mediums.

2. The data storage device of claim 1, wherein the first circuit is adapted to:
transmit a command to the host system via an interface to request data related to the APM setting from the APM register; and
receive the data related to the APM setting from the host system in response to the request.

3. The data storage device of claim 1, wherein each storage device policy of the plurality of storage device policies represents an unique level on a scale ranging from highest power consumption and highest performance to lowest power consumption and lowest performance.

4. The data storage device of claim 3, wherein the plurality of APM settings of the APM register includes 255 register settings, and wherein the plurality of storage device policies includes a respective 255 storage device policies.

5. The data storage device of claim 1, wherein each storage device policy of the plurality of storage device policies represents a storage device configuration including power levels and performance characteristics related to selected circuitry associated with at least one of the first data storage medium and the second data storage medium, and wherein the third circuit applies the selected storage device policy to:
reduce power to selected circuitry associated with at least one of the first and second data storage mediums; and
selectively adjust performance settings associated with the first and second data storage mediums.

6. The data storage device of claim 1, wherein the controller is adapted to initiate a process to retrieve the APM setting from the APM register at selected intervals.

7. The data storage device of claim 1, wherein the plurality of policies comprises:
a first storage device policy to reduce power to the first data storage medium and to adjust a memory partitioning parameter to store data on the second data storage medium; and
a second storage device policy to provide power to the first data storage medium and to adjust the memory partitioning parameter to selectively store data to one of the first and the second data storage media.

8. The data storage device of claim 7, wherein the plurality of storage device policies comprises:
a third storage device policy having a first caching algorithm associated with the second data storage medium; and
a fourth storage device policy having a second caching algorithm associated with the second data storage medium.

9. The data storage device of claim 8, wherein the plurality of storage device policies comprises:
a fifth storage device policy having a first caching priority to identify performance intensive read access requests associated with the first data storage medium and to store data associated with the identified requests to the second data storage medium; and
a sixth storage device policy having a second caching priority to store data and expected logical block addresses in the second data storage medium.

10. A data storage device comprising:
a first data storage medium;
a second data storage medium;
a module adapted to store a plurality of storage device performance configurations;
a controller configured to:
retrieve host management data from a particular register of a host system, the host management data indicative of power consumption versus performance;
apply a selected storage device performance configuration from the plurality of storage device performance configurations based on the host management data; and
selectively adjust performance and power consumption parameters associated with the first data storage medium and the second storage medium based on the selected storage device performance configuration.

11. The data storage device of claim 10, wherein the controller is adapted to send a command to the host system to request the host management data and to receive the host management data in response to the request, wherein the command is executable by the host system to return a value stored at the particular register.

12. The data storage device of claim 10, further comprising:
an interface responsive to a host system;
wherein the selected storage device performance configuration includes:
a power configuration to reduce power to the first data storage medium;
a memory partitioning parameter to adjust a memory partitioning setting to store data on the second data storage medium; and
a caching policy associated with caching files onto the second data storage medium to adjust a cache setting.

13. The data storage device of claim 12, wherein the host management data indicative of power consumption versus performance comprises one of at least ten values that range from highest power consumption and highest performance to lowest power consumption and lowest performance, and wherein a response time of the controller varies based on the selected storage device policy.

14. The data storage device of claim 12, wherein the first data storage medium is a disc storage medium and the selected storage device policy is applied to:
alter a memory partitioning policy to control when data is stored on the disc storage medium; and
alter a servo loop parameter associated with the disc storage medium.

15. The data storage device of claim 10, wherein the controller receives the host management data from a register of the host system, and wherein the selected storage device policy is applied to:
reduce power to the first data storage medium; and
selectively reduce power to read/write circuitry associated with the second data storage medium.

16. A system comprising:
a data storage device comprising:
an interface adapted to receive data and commands from a host system having a register with a plurality of register settings that represent a management configuration;
a first data storage medium;
a second data storage medium;
a controller adapted to:
implement a plurality of storage device configurations;
retrieve data from the register;
select a storage device configuration from the plurality of storage device configurations based on the retrieved data; and
apply the selected storage device configuration to alter at least one performance characteristic of the first data storage medium and the second data storage medium according to the selected storage device configuration.

17. The system of claim 16, wherein the first data storage medium comprises a disc data storage medium, and wherein the second data storage medium comprises a solid-state data storage medium.

18. The system of claim 17, wherein the management configuration comprises an acoustic management configuration including at least ten different acoustic configurations related to audible signals caused by rotation of the disc data storage medium, wherein the selected storage device configuration comprises a power setting associated with rotation of the disc data storage medium to adjust acoustic noise from rotation of the disc data storage medium.

19. The system of claim 16, wherein the management configuration comprises a power management setting for the host system, the power management setting corresponding to at least one of the plurality of storage device configurations, wherein the controller selectively applies the at least one of the plurality of storage device configurations to implement a power management setting for the data storage device.

20. The system of claim 16, wherein the plurality of register settings includes at least one hundred register settings;
wherein the plurality of storage device configurations includes a respective at least one hundred storage device configurations;
wherein each storage device configuration comprises an unique combination of power, acoustic, and performance settings relative to other storage device configurations of the plurality of storage device configurations; and
wherein the at least one performance characteristic comprises a caching algorithm that is adjustable based on the received data to control caching between the first data storage medium and the second data storage medium.

21. The system of claim 20, further comprising:
a cache memory device; and
wherein the at least one performance characteristic further comprises a cache prioritization algorithm to adjust when data is written to the cache memory device.

22. The system of claim 21, wherein the at least one performance characteristic comprises a power consumption characteristic:
wherein power to the first data storage medium is reduced from a first power level to a second power level during a first mode;
wherein power to the first data storage medium is increased from the second power level to the first power level during a second mode; and
wherein power to the first data storage medium is increased further to a third power level during a third mode.

23. The system of claim 22, wherein a timing characteristic is determined from the retrieved data to specify an amount of time before the controller switches modes.

24. The system of claim 20, further comprising:
a cache memory device; and
wherein the at least one performance characteristic further comprises a cache prioritization algorithm to adjust which data is written to the cache memory device.
